(19) United States
(12) Patent Application Publication
(10) Pub. No.: US 2002/0025031 A1
(43) Pub. Date: Feb. 28, 2002

(54) Network address conversion method and apparatus

(75) Inventors: Atsushi Maeda, Osaka (JP); Eiji Yuasa, Ibaraki (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/823,259

(22) Filed: Mar. 30, 2001

(30) Foreign Application Priority Data
Aug. 24, 2000 (JP) 2000-254550

(51) Int. Cl. H04M 1/00; H04M 3/00

(52) U.S. Cl. 379/355.04

(57) ABSTRACT

Network logical addresses are converted to temporary addresses which are more easily input using keys, typically ten keys, of mobile phones. Each character of the original address is replaced by a numeral, the numeral key being assigned to the character. In a certain phone, for example, key “2” is assigned to “2”, “A”, “B” and “C” and key “3” is assigned to “3”, “D”, “E” and “F”. If the original address includes “CE” as part of it, these two characters are converted simply to “23”. In the preparation step, the original addresses of web sites are converted to temporary addresses and the relation between them is registered in a table. By referring to the table, it would be easy to translate a temporary address to its original address so that correct access to the target site is enabled.

### BACKGROUND OF THE INVENTION

1. Field of the Invention

This invention relates to a logical address conversion technique, and especially to a network logical address conversion method and apparatus.

2. Description of the Related Art

IT or information technology will certainly lead all industries of the 21st century all over the world. The IT boom is based on various aspects, and especially on progress of network technology and proliferation of personal information terminals. The former has entered our daily life as the number of Internet users rapidly grows. The latter is symbolized in the fact that the number of PC's sold in Japan last year for the first time exceeded that of TV sets sold. PDAs or personal digital assistants and handy phones are also rapidly gaining user numbers. Users like mobile devices on which they can check daily schedules and necessary information. Mobile phones connectable to the Internet are especially popular as normal voice communication and browser functions are both realized in a compact unit.

Mobile devices are attractive simply because they are small and light. Manual operability is, however, lost to some extent in order to keep the body small. Ten keys are usually used in mobile phones to input alphabetic characters to register the names of people in a phone number directory and to input the URL of web sites. For example the numeric key “2” is also assigned to alphabet characters “A”, “B” and “C” so that the numeral and the three alphabet characters(hereinafter simply referred to “characters”) appear cyclically on the LCD. A full keyboard of an ordinary PC is of course more comfortable to input arbitrary characters.

### SUMMARY OF THE INVENTION

It is therefore an object of the present invention to provide a method and apparatus to input characters more easily and/or accurately for devices having only small keyboards.

According to one aspect of the present invention, a method for converting a network logical address such as a URL or uniform resource locator used in World Wide Web is provided.

The method comprises obtaining an inputted temporary logical address (hereinafter referred to also as “temporary address”) and searching for a real logical address (hereinafter referred to also as “real address”) corresponding to the inputted temporary address. The search is conducted on the assumption that at least part of the inputted temporary address has been generated by replacing each digit of the real logical address with a numeral assigned thereto in an information terminal.

The real address is a normal logical address assigned in the network. The word “real” is given to distinguish it from the temporary address, which is adopted in this method.

In this method, the temporary address is converted to the real address. These two addresses are both logical. In this sense the conversion of the present method is different from the conversion between a logical address and a physical address conducted in a DNS or domain name server of the WWW. A real address is for example “AX”. In a certain mobile phone, characters “A” and “X” are assigned to numeric keys “2” and “9”, respectively. In this case, the temporary address corresponding to “AX” may be “29”. The mentioned search is conducted assuming the real and temporary addresses have the above correspondence or the like.

Accepting the above assumption, a user can simply type “29” instead of “AX” to input “AX”. Inputting “29” is easier with ten keys. “29” can be identified as “AX” perfectly or to some degree, depending on the situation.

It is sufficient to assume that not all but only part of the digits of the inputted temporary address have been converted, as the sole objective here is to identify the correspondence between the real address and the temporary address. A part of the digits are sufficient to serve this purpose.

According to another aspect of the present invention, a network logical address conversion method is provided. The method comprises a preprocess and a main process. The preprocess comprises obtaining an inputted real logical address, identifying numerals, each thereof being assigned in an information terminal to each character of the inputted address, generating a temporary logical address corresponding to the real address by replacing at least some of the characters with the identified numerals, and storing the generated temporary address. The main process comprises obtaining an inputted temporary address and searching for a real address corresponding to the inputted address in a set of stored temporary addresses.

In the previous example, the address holder of the real address “AX” can register the corresponding temporary address “29” in the preprocess. In the main process in turn, the real address “AX” is identified from the temporary address “29” using the relation therebetween stored in the preprocess.

According to still another aspect of the present invention, a network address conversion apparatus is provided. The apparatus comprises a first address obtaining unit which obtains an inputted real logical address, a converter which converts the inputted address to a corresponding temporary address, a table which stores the input real address with the temporary address linked thereto, a second address obtaining unit which obtains an input temporary logical address, and a search unit which searches for a real logical address corresponding to the input temporary address.

The converter identifies a numeral assigned to a key of an information terminal, the key being used to input a character of the real address, the character corresponding to the numeral, and generates the temporary address corresponding to the real address by replacing at least some of the characters of the real address with the identified numerals.

The first address obtaining unit is used for the preparation of the registration of the real address. The real address obtained by the first unit is converted to the temporary address by the converter, and the temporary address is then stored in the table. The second address obtaining unit on the other hand is used when the temporary address is actually used. The original real address corresponding to the temporary address obtained by the second unit is selected from the table by the search unit. The user can use the temporary address for the initial input, and the final access to arbitrary network resources or the destination is executed using the real address.

According to yet another aspect of the present invention, a network address conversion apparatus is provided. The apparatus comprises a table storing correspondences between temporary logical addresses and real logical addresses, an address obtaining unit which obtains an inputted temporary address, and a search unit which searches for a real address corresponding to the inputted temporary address in the table. At least part of the inputted temporary address has been generated by replacing each character of the real logical address with a numeral assigned thereto in an information terminal.

This summary of the invention does not necessarily describe all necessary features so that the invention may also be a sub-combination of these described features.

### BRIEF DESCRIPTION OF THE DRAWINGS

FIG. 1 is a network system to which the address conversion apparatus of a preferred embodiment is applied;

FIG. 2 is a block diagram of the apparatus of the preferred embodiment;

FIG. 3 shows the data structure of a correspondence table of the apparatus;

FIG. 4 is a block diagram of a candidate processor of the apparatus;

FIG. 5 is a flowchart of a preprocess;

FIG. 6 shows conversion of a real address to a temporary address;

FIG. 7 is the data structure of an address table of the apparatus;

FIG. 8 is a flowchart of a main process;

FIG. 9 shows a screen to select a logical address inputting mode;

FIG. 10 shows a screen to input a temporary address; and

FIG. 11 shows a screen on which a plurality of real address candidates are displayed.

### DETAILED DESCRIPTION OF THE INVENTION

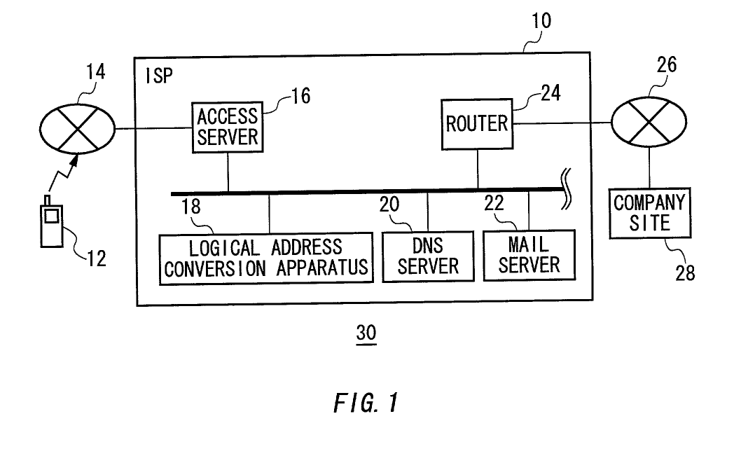

FIG. 1 is a network system 30 to which a logical address conversion apparatus 18 is applied. The system 30 comprises a mobile terminal 12 which is a mobile phone, a digital network 14 to which the mobile terminal 12 is connected, an Internet service provider or ISP 10 which connects the mobile terminal 12 to the Internet 26 and a company web site 28 connected to the Internet 26 without going through the ISP 10.

The ISP 10 not only provides a connecting function to the mobile terminal 12, but also serves as a logical address conversion portal site having an address conversion apparatus 18. The ISP 10, according to its general nature, comprises an access server 16, a DNS server 20, a mail server 22 and a router 24. The address conversion apparatus 18 converts a logical address or a URL input by the mobile terminal 12 to the corresponding real address when the URL is a temporary address, and outputs the real address to the DNS server 20. The DNS server 20 converts the real address to an IP address and connects the mobile terminal 12 to a desired site.

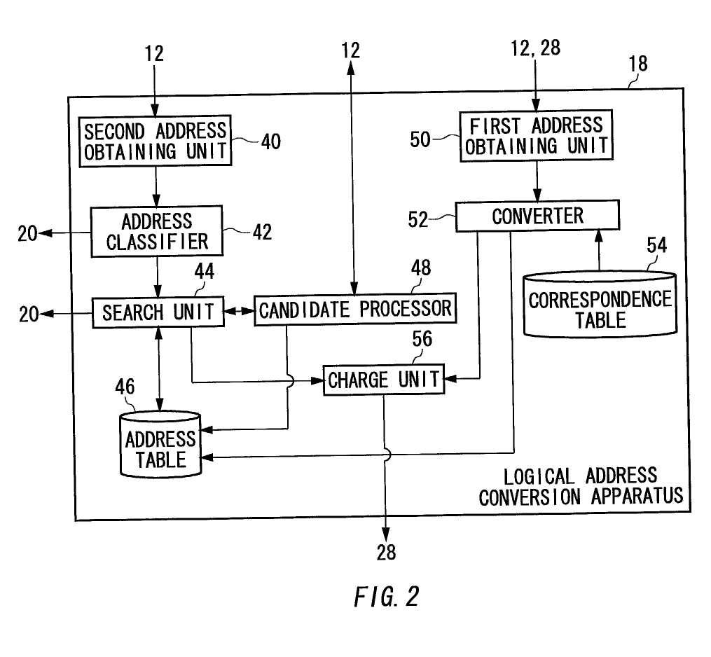

FIG. 2 is a block diagram of the address conversion apparatus 18 according to a preferred embodiment of the present invention. The functional blocks here can be realized with hardware circuitry including a CPU, memory and other LSI components of an arbitrary computer, or with software modules including a logical address converter program loaded in the memory. FIG. 2, however, shows only the functional blocks realized by various combinations of the above hardware/software collaboration.

The address conversion apparatus 18 comprises, for the preparation stage of the conversion, a first address obtaining unit 50, a converter 52, a correspondence table 54 and an address table 46. The first address obtaining unit 50 receives the request for registration of real addresses from mobile phone users, company sites 28 and so on. The company sites 28 may request registration after converting the real addresses to the temporary addresses to invite more users to their WWW sites or pages, as the user can more easily input the URL's of the company sites 28 after their conversion and registration (herein after referred to simply as “registration”). Mobile phone users may request their favorite site to be registered for easier future access.

The first address obtaining unit 50 sends to the converter 52 the real addresses received from the mobile phone users and company sites 28. The converter 52 converts the real addresses to the temporary addresses by referring to the correspondence table 54, and stores the combinations to the address table 46.

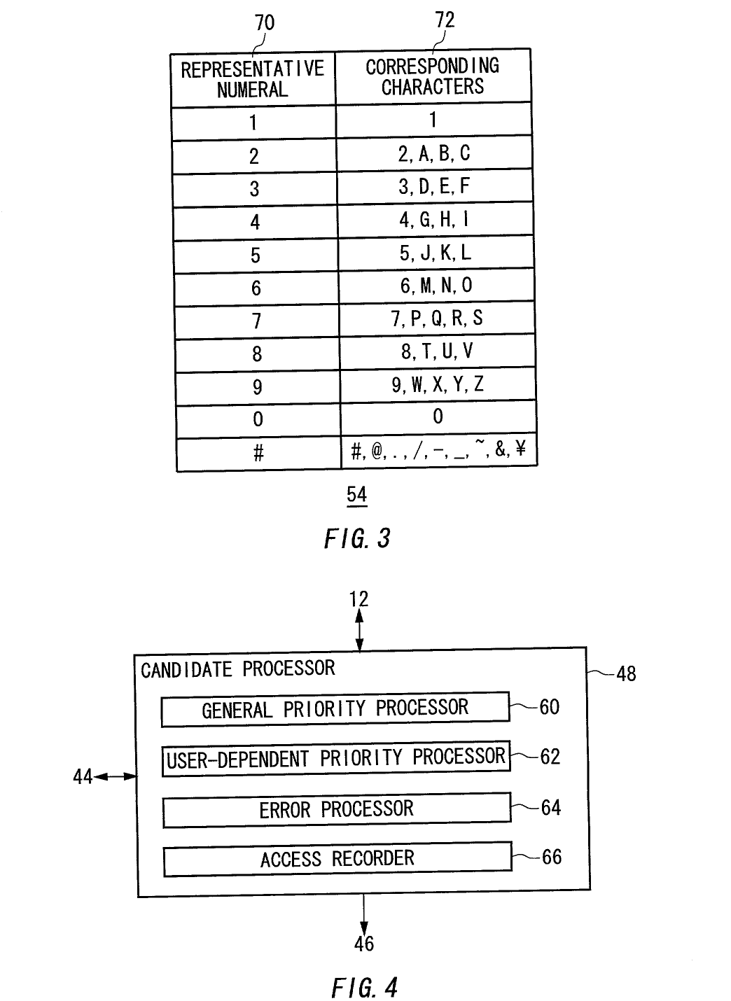

FIG. 3 shows the structure of the correspondence table 54. The correspondence table 54 describes the correspondence between the ten keys and the “#” key (hereinafter referred to as “representative numerals 70”), and the associated sets of alphabet characters, numerals and other types of symbols (hereinafter referred to as “characters 72”), assuming a typical key arrangement of the mobile terminal 12. A representative numeral “2” for example corresponds to a set of characters {2, A, B, C}. The converter 52 replaces each character of the real address with its corresponding representative numeral 70 by referring to the correspondence table 54, and generates the temporary address. Thus the preprocess ends.

For the main process, the address conversion apparatus 18 further comprises a second address obtaining unit 40, an address classifier 42, a search unit 44, a candidate processor 48 and an address table 46. The second address obtaining unit 40 receives a logical address input at the mobile terminal 12. It is not known at this stage whether the input address is a temporary address or a real address. The input address is therefore sent to the address classifier 42.

The address classifier 42 judges whether it is temporary or real based on the format of the address and/or any additional information. If the address is judged to be real, then it is directly sent to the DNS server 20. If the address is judged to be temporary, then it is sent to trigger the search unit 44.

The search unit 44 searches in the address table 46 using the temporary address as a search key and sends the corresponding real address, if found, to the DNS server 20. If more than one possible real address or candidate is found, they are sent to the candidate processor 48. If no real address was found, then it is also reported to the candidate processor 48, which initiates an error process. A charge unit 56 charges for the service at the search unit 44 and/or at the converter 52. In one embodiment, the charge unit 56 only charges on company sites 28 which wish to improve the number of views of their web pages.

FIG. 4 shows the structure of the candidate processor 48. A general priority processor 60 judges priority from among plural candidates irrespective of the user who requested the conversion. Higher priority may be given to a candidate having a larger number of past accesses thereto. This statistical approach is convenient in specifying web sites which are generally more popular.

In contrast, a user-dependent priority processor 62 judges the priority based on who requested the conversion. Higher priority may be given to a candidate to which the user has visited at least once or more. This personal approach is more suitable for one-to-one type customized service.

The general priority processor 60 and the user-dependent priority processor 62 display on the screen of the mobile terminal 12 the candidates in the respective order of judged priority. When the user selects one of the candidates, the selected real address is sent to the DNS server 20. An access recorder 66 increments the access number of the selected real address in the address table 46 for future use, from the general priority processor 60 and user-dependent priority processor 62.

An error processor 64 in the candidate processor 48, when no candidates were found, informs the user of the search result using the screen. The user may then re-input the real address. The configuration of the network system 30 and the address conversion apparatus 18 has been described.

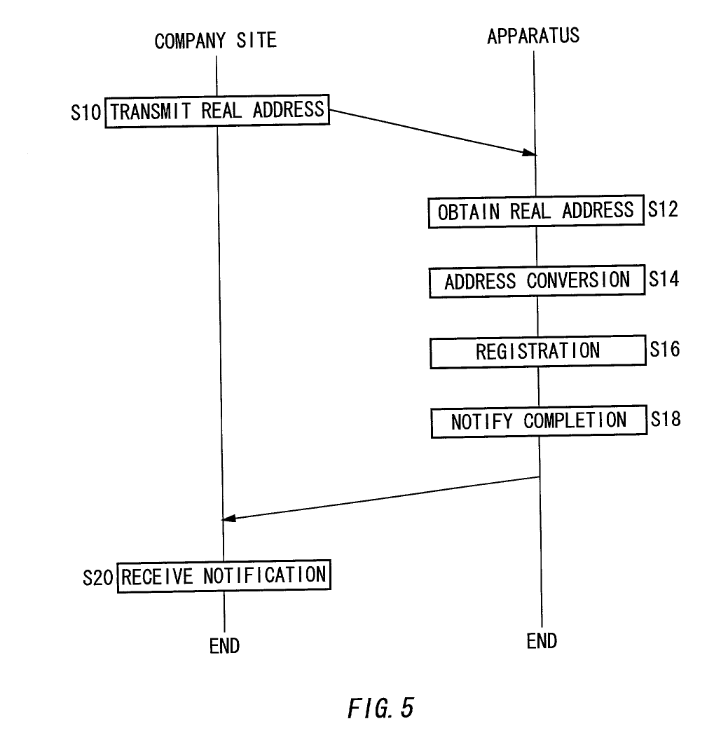

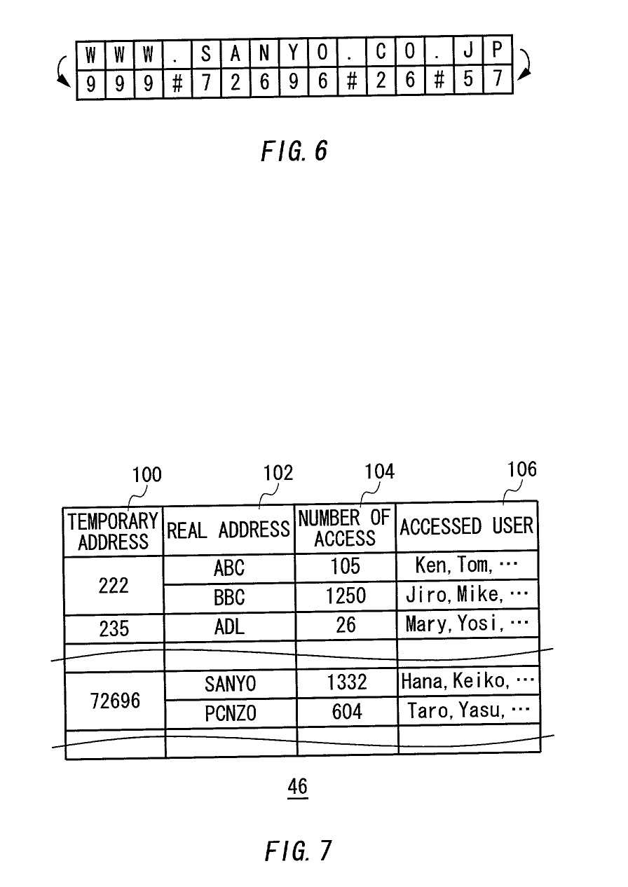

FIG. 5 shows the flow of the pre-process. FIG. 6 shows an example of the conversion. A company site 28 sends its URL “WWW.SANYO.CO.JP” to the address conversion apparatus 18 (S10). The first address obtaining unit 50 receives the URL (S12). The converter 52 converts it to the corresponding temporary address (S14) by replacing the characters of the real address with the representative numerals according to the correspondence table 54. The temporary address “999#72696#26#57” is generated as shown in FIG. 6. The generated address is registered to the address table 46 (S16) and the company site 28 is informed of the completion of the conversion (S18). Thus the preparation process is finished (S20).

FIG. 7 shows the structure of the address table 46. The address table 46 comprises a temporary address column 100, a real address column 102, an access number column 104, and an access user column 106. Here, the temporary address “999#72696#26#57” is abbreviated as “72696”. This is because URL's of companies in Japan frequently take the form of “WWW.****.CO.JP” and the characteristic part “72696” is noted. All the digits may of course also be noted.

Referring to the real address column 103, two real addresses “SANYO” and “PCNZO” exist for “72696” and the number of accesses made to the former is larger than that of the latter. Users having accessed the two addresses are Hana, Keiko, . . . and Taro, Yasu . . . , respectively. The access column 104 and the access user column 106 are effectively formed when actual access occurs.

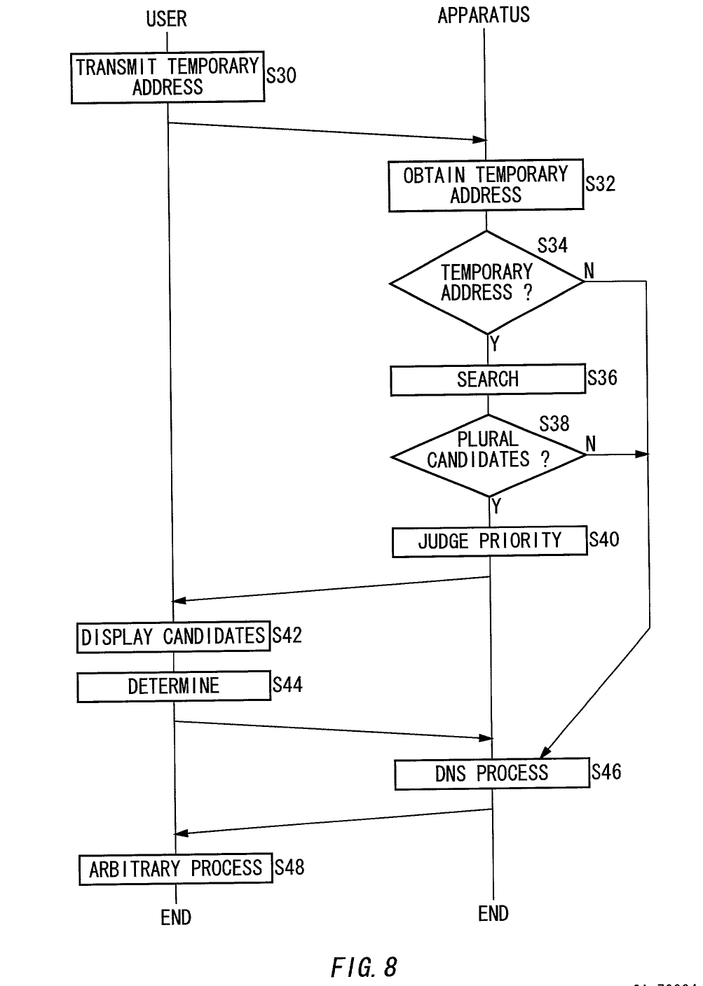

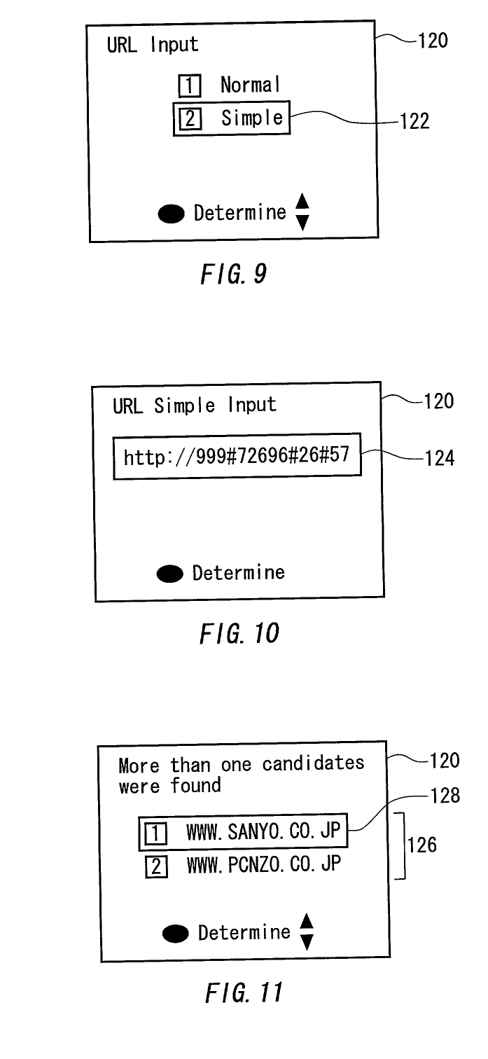

FIG. 8 shows the flow of the main process. FIGS. 9-11 show the screen of the mobile terminal 12 appearing during the process. The main process provides address conversion service to users.

A user inputs the temporary address “72696” to represent “SANYO” using the ten keys. The inputted address is transmitted to the address conversion apparatus 18 (S30). FIG. 9 shows the screen 120 displayed before the address is input. The user selects an input mode on the screen and in FIG. 9 a simple input mode 122, in which a temporary address is accepted, is selected. A special header, not shown, is attached to an address input in the simple input mode to show that the input address is a temporary address. The user can of course also select normal input mode. The address input in this mode is handled as a real address. FIG. 10 shows the input temporary address 24.

The second address obtaining unit 40 of the address conversion apparatus 18 obtains the input temporary address (S32). The address classifier 42 judges by detecting the foregoing header, whether the address is actually temporary (S34). If the address is real (S34N), it is sent to the DNS server 20 (S46). In the present case, the input address is a temporary address (S34Y) and is sent to the search unit 44, which conducts a search in the address table 46 (S36).

If only one candidate is found in the search (S38Y), the candidate is sent to the DNS server 20 as the desired real address (S46). In the present case, as shown in FIG. 7, two candidates “SANYO” and “PCNZQ” exist for “72696” (S38Y), the candidate processor 48 judges the priority (S40) and the result is displayed on the mobile terminal 12 (S42). In the default setting, the general priority processor 60 is active and selects based on the access number column 104 in FIG. 7 a candidate having a larger number of accesses. The user is informed that more than one candidate 126 is found and the first priority is given to “SANYO” which is listed in the first position 128 followed by “PCNZO”. If three or more candidates exist, the third and further candidates are listed in the same manner. When the user-dependent priority processor 62 is activated instead of the general priority processor 60 and when the user is identified as “Taro”, then “PCNZO” will be listed at the first position.

When the user selects “SANYO” (S44), it is sent to the address conversion apparatus 18 and the real address “WWW.SANYO.CO.JP” is sent to the DNS server 20 via the candidate processor 48 and the address table 46. The access recorder 66 increments the number of accesses to this site. The mobile terminal 12 is connected to this site after the necessary process at the DNS server 20 (S46). The user uses the site following this (S48).

One temporary address may have plural real addresses. Nevertheless the address conversion apparatus 18 efficiently works as follows. Each digit of a real address in the example of FIG. 3 is one of forty-five letters. Assuming the address has five digits, thus 45⁵ combinations are possible. Introducing the temporary address “72696”, the number of possible combinations is effectively limited to about 1/10,000, as each digit has corresponding characters as below and as

(5/45)×(4/45)×(4/45)×(5/45)×(4/45) is roughly 1/10,000.

7: {7, P, Q, R, S}

2: {2, A, B, C}

6: {6, M, N, O}

9: {9, W, X, Y, Z}

6: {6, M, N, O}

Although the present invention has been described using a few embodiments, it should be understood that many variations and modifications may be made within the spirit and the scope of the present invention which is defined only by the appended claims. A few modifications are as follows.

1. The preparation step is not essential and the address conversion apparatus 18 may autonomously judge real addresses. For this purpose, the address conversion apparatus 18 may execute the following steps:

1) obtaining an inputted temporary address;

2) identifying a set of characters for each digit of the temporary address, the set of characters being assigned to a key of an information terminal used to input the digits;

3) obtaining a group of addresses including the real address by arranging the identified sets of characters; and

4) selecting the real address out of the group as an intended real address.

Here “characters” include numerals and symbols. Let the temporary address be “23”. Representative numerals “2” and “3” have sets of assigned corresponding characters 72 U1={2, A, B. C} and U2={3, D, E, F}, respectively. Aforementioned groups of characters are therefore sixteen combinations “23”, “2D”, “2E”, . . . , “CE” and “CF”, each composed of one character from U1 and another from U2.

The real address is among the sixteen groups and assume it to be “CE”. In the above step 4), it is possible to identify the real address i) based on a user's instruction, ii) based on past access record, and iii) by selecting a group whose characters compose an existing word. Thus the pre-process may be skipped.

2. A circulating robot may be implemented in the address conversion apparatus 18 to automatically visit arbitrary web sites to register the addresses thereof.

3. Different terminals may have different key arrangements. The address conversion apparatus 18 may have a “terminal type detector” and plural corresponding tables 54 to cope with the different arrangements.

4. Characters representing logical network addresses are not necessarily limited to numerals, alphabets and symbols. Temporary addresses are not necessarily ten key based numerals and symbols. The sole necessity is that temporary addresses are in one sense or another more convenient than real addresses.

5. The whole or part of the address conversion apparatus 18 may be provided not inside but outside the ISP 10, for example in the mobile terminal 12 or the company site 28. Functions of the address conversion apparatus 18 may be divided and placed at one or more locations in the network.

What is claimed is:

1. A network logical address conversion method comprising:
obtaining an inputted temporary logical address; and
searching for a real logical address corresponding to the inputted temporary address,
wherein the search is conducted on the assumption that at least part of the inputted temporary address has been generated by replacing each character of the real logical address with a numeral assigned thereto in an information terminal.

2. A network logical address conversion method comprising a preprocess and a main process,
wherein the preprocess comprises:
obtaining an inputted real logical address,
identifying numerals, each thereof being assigned in an information terminal to each character of the inputted address;
generating a temporary logical address corresponding to the real address by replacing at least some of the characters with the identified numerals; and
storing the generated temporary address, and
wherein the main process comprises:
obtaining an inputted temporary address; and
searching for a real address corresponding to the inputted address in the set of stored temporary addresses.

3. The method of claim 2, wherein the search comprises detecting in the set a temporary address which is equal to the inputted temporary address, and identifying a real address from which the detected temporary address has been generated.

4. The method of claim 1, further comprising indicating a highly probable candidate as an expected real address when a plurality of real addresses are found in the search.

5. The method of claim 2, further comprising indicating a highly probable candidate as an expected real address when a plurality of real addresses are found in the search.

6. An network address conversion apparatus comprising:
a first address obtaining unit which obtains an inputted real logical address;
a converter which converts the inputted address to a corresponding temporary address;
a table which stores the inputted real address with the temporary address linked thereto;
a second address obtaining unit which obtains an inputted temporary logical address; and
a search unit which searches for a real logical address corresponding to the inputted temporary address;
wherein the converter identifies a numeral assigned to a key of an information terminal, the key being used to input a character of the real address, the character corresponding to the numeral, and generates the temporary address corresponding to the real address by replacing at least some of the characters of the real address with the identified numerals.

7. The apparatus of claim 6, further comprising a candidate processor which, when a plurality of real addresses capable of corresponding to the temporary address have been found by the search unit, indicates the found real addresses in a manner such that a higher probability candidate is listed with priority.

8. The apparatus of claim 6, further comprising a charge unit which charges for service processed by the search unit and/or the converter.

9. The apparatus of claim 7, further comprising a charge unit which charges for service processed by the search unit and/or the converter.

10. The apparatus of claim 6, further comprising an address classifier which judges whether the logical address obtained by the second address obtaining unit is a temporary address and which initiates the search based on the judgment.

11. The apparatus of claim 7, wherein the candidate processor comprises a general priority processor which indicates the same set of candidates to different users.

12. The apparatus of claim 11, wherein the general priority processor presents with priority a real address having a larger number of accesses thereto.

13. The apparatus of claim 7, wherein the candidate processor comprises a user-dependent priority processor which indicates a different set of candidates to a different user.

14. The apparatus of claim 13, wherein the user-dependent priority processor presents with priority to a user a real address having a larger number of accesses thereto by the user.

15. The apparatus of claim 7, wherein the apparatus is implemented in an Internet service provider.

16. The apparatus of claim 7, wherein the real address is a Uniform Resource Locater.

17. The apparatus of claim 7, wherein the temporary address is a series of numerals assigned in an informational terminal to respective keys used to input respective characters of the real address.

18. A network address conversion apparatus comprising:
a table storing correspondence between temporary logical addresses and real logical addresses;
an address obtaining unit which obtains an inputted temporary address; and
a search unit which searches for a real address corresponding to the inputted temporary address in the table,
wherein at least part of the inputted temporary address has been generated by replacing each character of the real logical address with a numeral assigned thereto in an information terminal.

19. A network address conversion method comprising:
obtaining an inputted temporary logical address;
identifying a set of characters for each digit of the temporary address, the set of characters being assigned to a key of an information terminal used to input the digit;
obtaining a group of addresses including the real address by arranging the identified sets of characters; and
selecting the real address out of the group as an intended real address.
